(19) United States
(12) Patent Application Publication
(10) Pub. No.: US 2022/0108252 A1
(43) Pub. Date: Apr. 7, 2022

(54) DYNAMIC LIFECYCLE PROFILING OF COMPUTING ASSETS FOR ENVIRONMENTALLY SUSTAINABLE DISPOSITION

(71) Applicant: Microsoft Technology Licensing, LLC, Redmond, WA (US)

(72) Inventors: Anand NARASIMHAN, London (GB); Paul CLARK, Snoqualmie, WA (US); Kesava VISWANATHAN, Sammamish, WA (US); David BEYER, Hessen (DE); Ranganathan SRIKANTH, Redmond, WA (US); Michael Warren ELLIS, Woodinville, WA (US); Lorraine Elizabeth TEW, Berkshire (GB); Robin Amanda SMITH, Redmond, WA (US)

(21) Appl. No.: 17/061,734

(22) Filed: Oct. 2, 2020

(51) Int. Cl. G06Q 10/06; G06Q 10/00; G06N 5/04; G06Q 50/26

(52) U.S. Cl. CPC G06Q 10/06375; G06Q 10/30; G06Q 50/26; G06Q 10/06315; G06N 5/04

(57) ABSTRACT

In non-limiting examples of the present disclosure, systems, methods and devices for generating sustainability insights and recommendations are presented. An asset disposition service may maintain a library comprising a plurality of software objects. Each of the software objects may correspond to a hardware computing asset and each software object may have a plurality of attributes associated with it related to the physical makeup of the asset, the software executed by the asset, regulatory issues associated with the asset, or contractual terms associated with the asset. The asset disposition service may apply various algorithms and/or machine learning models to one or more attributes of the software objects to generate sustainability insights and recommendations that can be utilized to identify best disposition paths for assets and for meeting sustainability goals.

### BACKGROUND

Disposition of items is a broad and well understood field across many industries and supply chains. There is a need to manage the handling of computing assets across lifecycle phases, especially towards the end of their active usefulness from an originally intended purpose. As supply chains grow more complex and global, with many intricate relationships and interactions between items along with their components, assemblies, and various entities that perform activities on these items, so too does the need to identify best disposition routes from sustainability, regulatory, contractual, and cost standpoints.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for generating and surfacing sustainability insights and recommendations. Examples described herein provide an asset disposition service that includes a plurality of modules that work in coordination to extract data from the stages of the lifecycle of computing assets across a supply chain. The asset disposition service may incorporate the use of a dynamic profile for each computing asset and for entities in the supply chain. The profile may change over time and with the changing contexts of the use of the computing asset, the participating entities, and various internal and external influences that may have relevance to underlying regulatory requirements associated with the computing asset. Further, the profile may be informed by environmental sustainability guidelines that are determinative of whether a specific entity, activity, or attribute relevant to a computing asset is suitable for the disposition of the computing asset. Determinations of economic or other value of a computing asset may also inform the dynamic nature of the profile.

The profile described above may be incorporated in a software object for each computing asset. The asset disposition service may maintain an asset object library comprised of these software objects. Each software object may represent hardware computing assets that are managed by the asset disposition service. Each of the software objects may comprise a plurality of attributes. The attributes may relate to one or more phases of a computing asset's lifecycle. The asset disposition service may apply various models to these attributes to determine a best disposition route for an asset, to generate sustainability insights related to computing assets, and to generate sustainability recommendations related to computing assets.

### BRIEF DESCRIPTION OF THE DRAWINGS

Non-limiting and non-exhaustive examples are described with reference to the following figures:

FIG. 1 is a schematic diagram illustrating an example distributed computing environment for generating and surfacing sustainability insights and recommendations.

FIG. 2 illustrates a simplified block diagram of a software object that may be included in an asset object library.

FIG. 3 illustrates a simplified computing environment for generating sustainability insights based on processing of data related to cloud computing software objects included in an asset object library.

FIG. 4 illustrates a plurality of sustainability insights surfaced on a cloud computing dashboard user interface.

FIG. 5 illustrates a plurality of sustainability insights surfaced on a cloud computing emissions user interface.

FIG. 6 is an exemplary method for generating and surfacing interactive sustainability insights.

FIG. 7A is an exemplary method for providing a recommendation related to the supply chain of a computing asset.

FIG. 7B is an exemplary method for providing a recommendation related to repurposing of a software object for a second phase of its computing lifecycle.

FIGS. 8 and 9 are simplified diagrams of a mobile computing device with which aspects of the disclosure may be practiced.

FIG. 10 is a block diagram illustrating example physical components of a computing device with which aspects of the disclosure may be practiced.

FIG. 11 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for generating and surfacing sustainability insights and sustainability recommendations. Additional examples provide mechanisms for assisting with identifying best courses of action in relation to computing asset disposition, including factors that affect computing assets (e.g., data center power, cooling equipment). As described herein computing asset disposition refers to the optimal handling of a computing asset at any phase of the computing asset's lifecycle. The optimization may be based on sustainability factors, contractual factors, risk factors, regulatory factors, and/or cost factors.

An asset disposition service may maintain an asset object library comprised of software objects. Each software object may represent a computing asset (e.g., a server, a router) that is managed by the asset disposition service. Each of the software objects may comprise a plurality of attributes that may be utilized in determining a best disposition path for the corresponding computing asset for a given lifecycle phase. Various computing models may be applied to the attributes to determine best disposition paths for computing assets, as well as to generate sustainability insights and sustainability recommendations and decisions.

In some examples, the asset disposition service may apply a carbon footprint prediction model to computing workload attributes and energy type attributes of data center computing assets to generate carbon footprint projections and related sustainability insights. In some examples, the asset disposition service, alone or in combination with one or more additional services or engineering teams, may determine projected computing workload use by companies utilizing cloud computing assets managed by the asset disposition service. That determination may be made via application of a predictive simulation model (e.g., a Monte Carlo model) to cloud service demand variables and cloud service supply variables. In additional examples, the asset disposition service may apply a carbon footprint prediction model to sustainability values (e.g., shipping fuel type, shipping locations) associated with vendors in the supply chain of a computing asset to generate carbon footprint projections and related sustainability recommendations. In still additional examples, the asset disposition service may apply a route optimization computing model to object attributes associated with government regulations or contractual clauses to determine whether a corresponding computing asset may be repurposed by secondary entities or for secondary purposes after its primary purpose has been exhausted.

The systems, methods, and devices described herein provide technical advantages for determining best disposition routes for computing assets. Processing costs associated with determining whether moving computing workloads to different data centers and their corresponding computing assets will result in reduced greenhouse gas emissions are reduced via the mechanisms described herein. As used herein, CO2 may refer to carbon dioxide equivalent (CO2e) and the values may be in metric tons (e.g., mtCO2e). For example, by maintaining an asset object library comprised of software objects corresponding to computing assets, sustainability insights and recommendations can be made on the fly, without having to put in individual processing requests to each organization and/or entity in the supply chain of those computing assets. Processing costs are further reduced via the mechanisms described herein in that computing assets can be dynamically monitored via their software objects to determine whether software at the data center level can be more efficiently run (e.g., utilize less energy or be less of a burden on the energy grid at certain times of day or night). Additionally, by allowing users to quickly and easily view their sustainability metrics (e.g., CO2 emission data) related to use of cloud computing services, adopting greener fuel types, and more ecological shipping and sourcing practices, the mechanisms described herein encourage and promote the reduction of greenhouse gas emissions at all levels of the supply and use chains for computing assets.

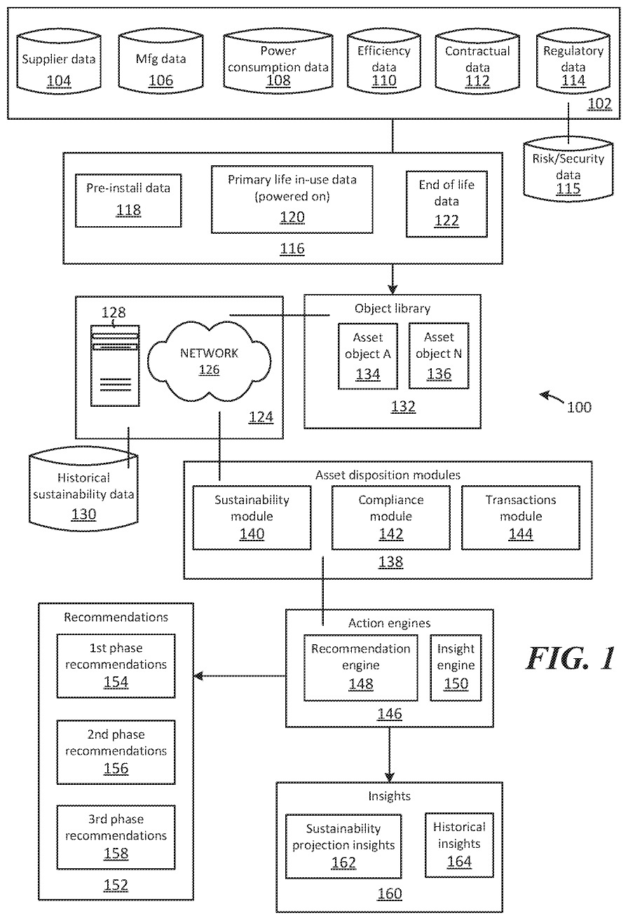

FIG. 1 is a schematic diagram illustrating an example distributed computing environment 100 for generating and surfacing sustainability insights and recommendations. Computing environment 100 includes data stores sub-environment 102, data types sub-environment 116, network and processing sub-environment 124, asset object library sub-environment 132, historical sustainability data store 130, asset disposition modules sub-environment 138, action engines sub-environment 146, recommendations sub-environment 152, and insights sub-environment 160.

Network and processing sub-environment 124 includes network 126 and server computing device 128. Any of the computing devices described herein may communicate with one another via a network, such as network 126. Server computing device 128 is exemplary of one or more computing devices that may execute an asset disposition service. The asset disposition service may comprise a plurality of software objects included in a software object library, such as asset object A 134 and asset object N 136 included in asset object library sub-environment 132. The asset disposition service may perform operations associated with the software objects to identify best courses of action to take in relation to the physical counterparts of the software objects to minimize environmental impact from a greenhouse gas emissions/carbon footprint standpoint, while maximizing value from an organizational and cost standpoint. In performing these operations, the asset disposition service may generate recommendations and insights related to asset disposition during a first phase of an asset's lifecycle, a second phase of an asset's lifecycle, and a third phase of an asset's lifecycle.

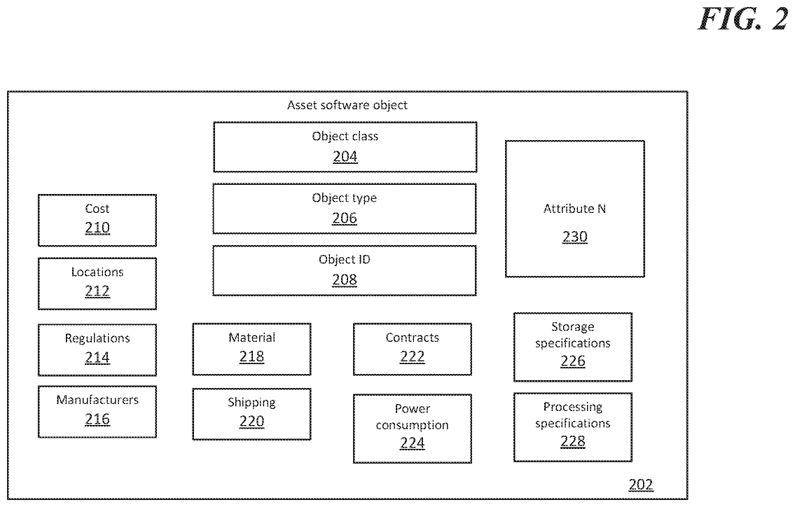

Asset object library sub-environment 132 includes asset object A 134 and asset object N 136. Asset object A 134 is illustrative of a specific software object, while asset object N 136 represents a plurality of additional software objects that may be maintained in asset object library sub-environment 132. Asset object A 134 and asset object N 136 each represent a computer hardware resource (e.g., a server computing device, a router, a switch, a client computing device). Each object in asset object library sub-environment 132 may comprise one or more sub-objects (e.g., computing devices or computing components) that makeup the larger object. For example, if asset object A 134 is a server computing device, it may comprise a first sub-object comprised of one or more processing objects and a second sub-object comprised of one or more memory objects. Each object in asset object library sub-environment 132 further includes a plurality of attributes. For example, object A 134 may comprise one or more of: an object class attribute, an object type attribute, an object ID attribute, one or more cost attributes, one or more locational attributes, one or more regulatory attributes, one or more manufacturing attributes, one or more material attributes, one or more shipping attributes, one or more contractual attributes, one or more power consumption attributes, one or more storage specification attributes, and one or more processing specification attributes. Additional description related to object attributes is provided below in relation to FIG. 2.

Data stores sub-environment 102 comprises supplier data store 104, manufacturing data store 106, power consumption data store 108, efficiency data store 110, contractual data store 112, regulatory data store 114, and risk/security data store 115. Although each of those data stores is illustrated as its own data store, it should be understood that one or more of the data stores in data store sub-environment 102 may be combined (e.g., a single data store may comprise one or more of the data stores illustrated in data store sub-environment 102). Each of the data stores included in data stores sub-environment 102 may be associated with the asset disposition service. Thus, the asset disposition service may receive and/or analyze data from data store sub-environment 102, associate that data with software objects in asset object library sub-environment 132, and use that data in generating sustainability and asset disposition recommendations and insights.

Supplier data store 104 may comprise data associated with computing hardware assets from one or more entities in the supply chain of materials and components utilized in the manufacturing of computing hardware assets. For example, supplier data store 104 may comprise identities and contact information of entities involved in sourcing raw and refined materials for computing assets, locations of entities associated with sourcing and refining materials for computing assets, a description of materials (e.g., steel, titanium, silicon) that make up a computing asset, weights associated with materials for computing assets, and costs associated with those materials.

Manufacturing data store 106 may comprise data associated with the manufacturing of computer hardware assets. For example, manufacturing data store 106 may comprise identities and contact information of entities involved in the manufacturing and shipping of computing assets, locations of entities associated with the manufacturing and shipping of computing assets, energy types used by those entities to manufacture and ship computing assets, and costs associated with the manufacture and shipping of computing assets by those entities.

Power consumption data store 108 may comprise data associated with the amount and type of power utilized in powering computer hardware assets. For example, power consumption data store 108 may comprise identities and locations (e.g., data center in Americas South East, data center in Europe West) where computing assets are deployed, and the types of power (e.g., hydroelectric, solar, gas) used to power the computing assets at those locations. Power consumption data store 108 may additionally include an amount of power used by each computing asset at each location, and a cost associated with the powering of computing assets at each location. In some examples, power consumption data store may include different power requirements for performing same operations at different times of the day for a same computing asset.

Efficiency data store 110 may comprise data associated with how efficient software and hardware of computing assets are running. For example, efficiency data store 110 may comprise identities of computing assets, types of software and/or hardware that are executed by those computing assets, what operations are executed by those computing assets, how much power those computing assets take to execute those operations, and what times and locations those operations are performed.

Contractual data store 112 may comprise data associated with contracts that involve computing assets. For example, contractual data store 112 may comprise contractual terms that have been entered into between owners and/or lessors of computing assets and one or more entities in the supply chain (e.g., manufacturers, distributors). Thus, contractual data store 112 may include contractual limitations on what types of actions can be taken with computing assets after their original computing lifecycle has been reached, and what entities may repurpose those computing assets. In some examples, data from contractual data store 112 may be analyzed by one or more natural language processing models associated with the asset disposition service to classify contractual terms and determine which software objects to associate them with in asset object library sub-environment 132. In some examples, contractual data store 112 may comprise smart contracts that are implemented and managed with blockchain technology. For example, the smart contracts may be decentralized, distributed, and utilize public or private encrypted ledgers that service to authenticate, validate and make available verification of associated transactions to establish authenticity.

Regulatory data store 114 may comprise data associated with government bodies that regulate computing assets. For example, regulatory data store 114 may comprise one or more laws or regulations affecting computing assets, and the identities of the computing assets that are affected by those laws or regulations. In some examples, data from regulatory data store 114 may be analyzed by one or more natural language processing models associated with the asset disposition service to classify regulations and determine which software objects to associate them with in asset object library sub-environment 132.

Risk/security data store 115 may comprise data associated with data privacy, user security concerns, supply chain safety, and national security concerns. For example, risk/security data store 115 may comprise one or more encryption policies associated with computing assets (and software running on those assets), security regulations, or manufacturing practices for various computing assets. Risk/security data store 115 may further include information related to whether a computing asset is bearing data or has potential for bearing data, has volatile or non-volatile memory, is subject to intellectual property rights or has potential for being subject to intellectual property rights, has market sensitivity or potential for market sensitivity from a competitive or other standpoint. Risk/security data store 115 may further include data related to whether a computing asset has a component or sub-assembly in another item or by introduction of instructions, logic or other hardware or software that could constitute a security attribute. Risk/security data store 115 may further include attributes that can be utilized to track deviations of other attributes from acceptable norms, such as deviation of a compliance attribute from stipulated guidelines that could pose a risk to an entity in an asset supply chain.

Historical sustainability data store 130 may comprise historical data from one or more of supplier data store 104, manufacturing data store 106, power consumption data store 108, efficiency data store 110, contractual data store 112, and regulatory data store 114.

In some examples, the asset disposition service may receive data from data store sub-environment 102 and apply lifecycle tags to it that may be associated with software objects in asset object library sub-environment 132 that the data affects. This is illustrated in data types sub-environment 116, where the incoming data may be tagged with pre-install data tag 118, primary life in-use data (powered on) tag 120, or end of life data tag 122. In some examples, data may be tagged as relating to more than one lifecycle. In other examples, data may bypass data types sub-environment 116 and therefore need not necessarily be tagged with a lifecycle tag before being associated with asset objects in asset object library sub-environment 132.

The asset disposition service may comprise a plurality of asset disposition modules that are utilized in generating insights and recommendations. These asset disposition modules are illustrated in asset disposition modules sub-environment 138, which includes sustainability module 140, compliance module 142, and transactions module 144. Sustainability module 140 may perform one or more operations associated with determining the sustainability requirements for disposition of computing assets managed by the asset disposition service, and/or generating sustainability insights and recommendations related to computing assets managed by the asset disposition service. Compliance module 142 may perform one or more operations associated with determining the compliance requirements for disposition of computing assets managed by the asset disposition service, and/or generating compliance insights and recommendations related to computing assets managed by the asset disposition service. Transactions module 144 may perform one or more operations associated with establishing and executing transactions between two or more entities to perform disposition activities associated with computing assets managed by the asset disposition service, and/or generating transactional insights and recommendations related to computing assets managed by the asset disposition service.

Asset disposition modules sub-environment 138 may additionally include one or more of an inventory module that maintains a view of all computing assets that are to be managed by the asset disposition service; a profiling module that creates a profile for each computing asset, and a profile for every actor and entity in the supply chain that is involved in the lifecycle of each computing asset; a prediction module that predicts optimal disposition routes and associates attributes for computing assets at various stages in the asset lifecycle; an estimation module that observes and estimates attributes for the optimal management of computing assets at various stages in computing assets' lifecycles; a resource module that determines the availability and sustainability of an entity to perform a disposition activity on computing assets; a scheduling module that schedules the disposition of computing assets on specific disposition routes; an activity module that manages the sequence of activities defined for specific disposition routes and performed on computing assets as a result of a valid transactions; a fulfillment module that ensures the fulfillment of disposition activities or transactions; and an exception module that manages any exceptions in actions performed in any module maintained by the asset disposition service to ensure satisfactory resolution of these exceptions.

Action engines sub-environment 146 includes action engines that may be executed by the asset disposition service and/or one or more asset disposition modules. Action engines sub-environment 146 includes recommendation engine 148 and insight engine 150. Recommendation engine 148 may analyze one or more objects in asset object library sub-environment 132, data from data store sub-environment 102, and/or data from historical sustainability data store 130, and generate recommendations associated with different phases of computing asset lifecycles. This is illustrated by recommendations sub-environment 152, which includes first phase recommendations 154, second phase recommendations 156, and third phase recommendations 158.

First phase recommendations 154 comprise recommendations corresponding to a first phase of a computing asset's lifecycle. The first phase of a computing asset's lifecycle includes all actions associated with a computing asset from the sourcing of materials for that asset to the installation and powering on of the computing asset. Thus, first phase recommendations 154 may include recommendations related to which sourcing and manufacturing entities to contract with in the sourcing of computing asset materials, manufacturing of computing assets, and shipping of computing assets. In examples, first phase recommendations 154 may be made based on sustainability metrics (e.g., estimated CO2e emissions) associated with one or more entities in the supply chain.

Second phase recommendations 156 comprise recommendations corresponding to a second phase of a computing asset's lifecycle. The second phase of a computing asset's lifecycle includes all actions associated with a computing asset when it is powered on and performing its primary intended use. In examples, second phase recommendations 156 may be made based on sustainability metrics (e.g., estimated CO2e emissions) associated efficiency in executing and hardware or software operations by a computing asset during its second phase.

Third phase recommendations 158 comprise recommendations corresponding to a third phase of a computing asset's lifecycle. The third phrase of a computing asset's lifecycle includes all actions associated with a computing asset from approximately the time that the computing asset is to be discarded, recycled, or repurposed from its primary intended use up through that discarding, recycling or secondary use. In examples, third phase recommendations 158 may be made based on sustainability metrics (e.g., estimated CO2e emissions) associated with discarding a computing asset, recycling a computing asset, or repurposing a computing asset for a secondary use.

Insight engine 150 may analyze one or more objects in asset object library sub-environment 132, data from data store sub-environment 102, and/or data from historical sustainability data store 130 and generate sustainability insights associated with computing assets managed by the asset disposition service. In some examples, insight engine 150 may modify values associated with various attributes of asset objects in asset object library sub-environment 132 and perform “what-if” analyses based on those modifications such that a variety of recommendations may be generated and surfaced. In some examples, these “what-if” analyses may be performed in association with a predictive simulation model. This is illustrated by insights sub-environment 160.

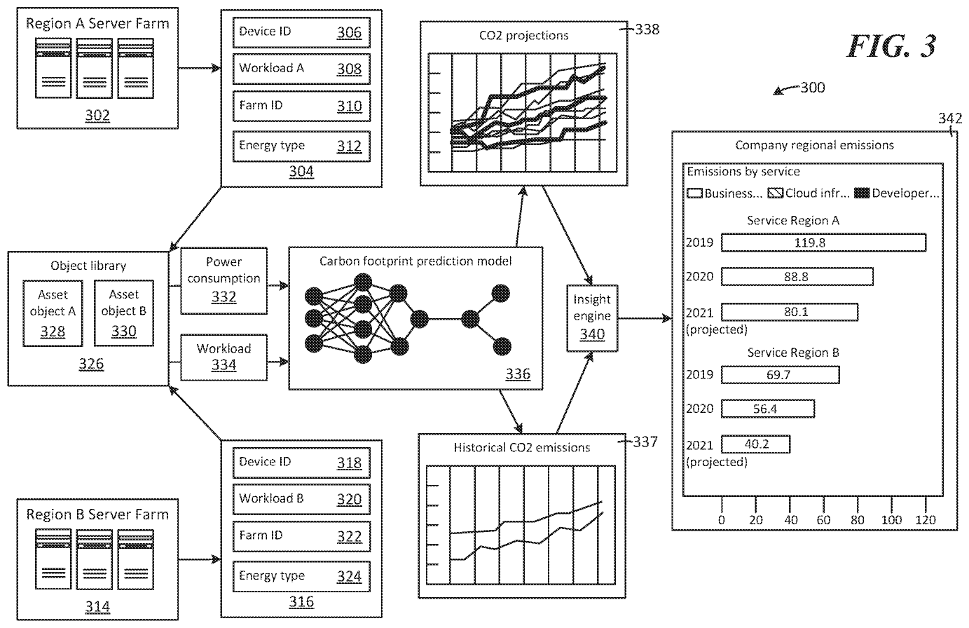

Insights sub-environment 160 includes sustainability projection insights 162 and historical insights 164. Sustainability projection insights 162 may comprise values, charts, graphs or other display objects that are generated to reflect sustainability metric projections (e.g., projected CO2e emissions) associated with the first phase, second phase, or third phase of a computing asset's lifecycle that is managed by the asset disposition service. In some examples, one or more modules associated with insights sub-environment 160 may utilize sustainability projection insights 162 in generating reports for compliance and reporting for government entities or other entities involved in greenhouse gas compliance. Historical insights 164 may comprise values, charts, graphs or other display objects that are generated to reflect current or past sustainability metrics (e.g., actual or estimated CO2e emissions) associated with the first phase, second phase, or third phase of a computing asset's lifecycle that is managed by the asset disposition service. In some examples, a sustainability projection insight may be combined with a historical insight. Sustainability insights and their generation is more fully described below in relation to FIGS. 3-5.

FIG. 2 illustrates a simplified block diagram of a software object 202 that may be included in an asset object library (e.g., asset object library sub-environment 132). Software object 202 comprises a plurality of attributes. Specifically, software object 202 corresponds to a hardware computing asset that is managed by the asset disposition service. Software object 202 comprises object class attribute 204, object type attribute 206, object ID attribute 208, cost attribute 210, locations attribute 212, regulations attribute 214, manufacturers attribute 216, material attribute 218, shipping attribute 220, contracts attribute 222, power consumption attribute 224, storage specifications attribute 226, processing specifications attribute 228, and attribute N 230. An attribute may be manually associated or updated in software object 202 via user input. In other examples, an attribute may be automatically associated or updated in software object 202 when data corresponding to an attribute is received by the asset disposition service. In some examples, one or more natural language processing models (e.g., BERT, ELMo, KNN) and/or machine learning models (e.g., neural networks that classify computing workload data) associated with the asset disposition service may be utilized in classifying incoming data and associating it with software objects as attributes.

Cost attribute 210 may comprise a cost of materials or services associated with software object 202. For example, cost attribute 210 may comprise a materials cost for materials utilized in the computing asset corresponding to software object 202, a manufacturing cost for manufacturing all or part of the computing asset corresponding to software object 202, a shipping cost for shipping the computing asset corresponding to software object 202 or materials utilized in the computing asset corresponding to software object 202, a purchase cost for the computing asset corresponding to software object 202 or materials utilized in the asset corresponding to software object 202, and/or a cost for energy utilized to power the computing asset corresponding to software object 202.

Locations attribute 212 may comprise locational information associated with software object 202. For example, locations attribute 212 may comprise geographic coordinates associated with suppliers of the computing asset corresponding to software object 202 (e.g., shipping locations, manufacturing locations, material sourcing locations, company headquarter locations), and/or geographic coordinates of one or more locations where the computing asset corresponding to software object 202 will reside or be operated during the first, second or third phase of its lifecycle.

Regulations attribute 214 may comprise regulatory information associated with software object 202. For example, regulations attribute 214 may comprise one or more regulations from one or more regulatory bodies (e.g., government bodies, agencies) that have regulatory control over the computing asset corresponding to software object 202 or to data handled by the computing asset corresponding to software object 202.

Material attribute 218 may comprise materials information associated with software object 202. For example, material attribute 218 may comprise identities of materials included in the computing asset corresponding to software object 202, weights of materials included in the computing asset corresponding to software object 202, identities of entities that provide or source materials included in the computing asset corresponding to software object 202, and/or regulations associated with materials included in the computing asset corresponding to software object 202. In some examples, material attribute 218 may comprise a percentage or weight of carbon in a given material (e.g., steel, aluminum).

Shipping attribute 220 may comprise shipping information associated with software object 202. For example, shipping attribute 220 may comprise identities of entities involved in shipping the computing asset corresponding to software object 202, costs associated with shipping the computing asset corresponding to software object 202, shipping locations associated with shipping the computing asset corresponding to software object 202, and/or energy types used in shipping the computing asset corresponding to software object 202.

Contracts attribute 222 may comprise contractual information associated with software object 202. For example, contracts attribute 222 may comprise contractual terms associated with the computing asset corresponding to software object 202 (e.g., contracts between the buyer of the computing asset and the manufacturer of the computing asset, contracts between shipping entities and the buyer of the computing asset), identities of contracting parties associated with the computing asset corresponding to software object 202, and/or end of life or lifecycle management conditions associated with the computing asset corresponding to software object 202.

Power consumption attribute 224 may comprise power consumption data associated with the powering of software object 202. For example, power consumption attribute 224 may comprise amounts of power that are utilized in powering the computing asset corresponding to software object 202, amounts of power that are utilized in executing specific operations that the computing asset corresponding to software object 202 executes, and/or timestamps associated with the performance of operations and/or powering of the computing asset corresponding to software object 202.

Storage specifications attribute 226 may comprise hardware or software storage specifications associated with software object 202. For example, storage specifications attribute 226 may comprise types of hardware storage (e.g., SSD, HDD) included in the computing asset corresponding to software object 202, and/or the types of information (e.g., user identifying information, encrypted data, financial data, health records) that is stored or going to be stored on the computing asset corresponding to software object 202.

Processing specifications attribute 228 may comprise hardware or software processing specifications associated with software object 202. For example, processing specifications attribute 228 may comprise types of processors included in the computing asset corresponding to software object 202, types of computing workloads that the asset corresponding to software object 202 is going to be processing or is processing, and/or amounts of computing workloads that the asset corresponding to software object 202 is going to be or is processing.

Attribute N 230 is representative of one or more additional attributes (e.g., risk attributes, security attributes) that may include data not directly related to or included in the other attributes illustrated in software object 202.

FIG. 3 illustrates a simplified computing environment 300 for generating sustainability insights based on processing of data related to cloud computing software objects included in an asset object library. Computing environment 300 includes region A server farm 302, region B server farm 314, region A data 304, region B data 316, object library 326, power consumption data 332, workload data 334, carbon footprint prediction model 336, historical CO2 emissions 337, CO2 emissions projections 338, insight engine 340, and sustainability insights 342.

Region A server farm 302 includes a plurality of computing assets (e.g., servers, routers) that are managed by the asset disposition service. Each of the computing assets in region A server farm 302 may have a corresponding software object (e.g., asset object A 328, asset object B 330) in object library 326. The computing assets in region A server farm 302 may send region A data 304 to the asset disposition service, which may associate that data with relevant software objects (e.g., as attributes) in object library 326. For example, region A data 304 includes device ID data 306, which may comprise identifying information for one or more computing assets included in region A server farm 302. Region A data 304 further includes workload A data 308, which may describe computing workloads handled by one or more computing devices included in region A server farm 302. Region A data 304 further includes farm ID data 310 and energy type data 312. Farm ID data 310 may include identifying information (e.g., name, geocoordinates, etc.) for region A server farm 302, and energy type data 312 may comprise the identity of one or more types of power sources that are utilized in powering the computing assets included in region A server farm 302.

Region B server farm 314 includes a plurality of computing assets (e.g., servers, routers) that are also managed by the asset disposition service. Each of the computing assets in region B server farm 314 may have a corresponding software object (e.g., asset object A 328, asset object B 330) in object library 326. The computing assets in region B server farm 314 may send region B data 316 to the asset disposition service, which may associate that data with relevant software objects (e.g., as attributes) in object library 326. For example, region B data 316 includes device ID data 318, which may comprise identifying information for one or more computing assets included in region B server farm 314. Region B data 316 further includes workload B data 320, which may describe computing workloads handled by one or more computing devices included in region B server farm 314. Region B data 316 further includes farm ID data 322 and energy type data 324. Farm ID data 322 may include identifying information (e.g., name, geocoordinates, etc.) for region B server farm 314, and energy type data 324 may comprise the identity of one or more types of power sources that are utilized in powering the computing assets included in region B server farm 314.

The asset disposition service may receive an indication to generate sustainability insights for region A server farm 302 and region B server farm 314. In some examples, the indication may be a user input that specifies the regions to generate the insights for, the workloads to generate the insights for, and/or the services to generate the insights for. The asset disposition service may identify the software objects in object library 326 corresponding to the server farms that it is generating insights for. The asset disposition service may additionally identify the attributes of those objects that are relevant to the insights that it is going to generate. The asset disposition service may then perform one or more processing operations, including applying one or more power consumption models and/or carbon footprint prediction models to the relevant object attributes to generate the sustainability insights.

The asset disposition service identifies power consumption attributes from region A server farm 302 and region B server farm 314, which is processed as power consumption data 332; and workload A data 308 and workload B data 320, which is processed as workload data 334. For example, the asset disposition service may take historical power consumption data from each of region A server farm 302 and region B server farm 314 (and in some examples energy type data 312 and energy type data 324), apply carbon footprint prediction model 336 to that historical data to determine carbon emission values for those respective server farms in the past, as illustrated by historical CO2 emissions 337. Those values may then be associated with the computing workloads that were the cause of the power consumption, and the server farm IDs, and transformed by insight engine 340 into historical sustainability insights (e.g., insights about past greenhouse gas emissions corresponding to data processing performed by region A server farm 302 and region B server farm 314). The historical sustainability insight insights in this example may include the CO2 emission bars corresponding to 2019 and 2020 under service region A in sustainability insights 342, as well as the CO2 emissions bars corresponding to 2019 and 2020 under service region B in sustainability insights 342.

The asset disposition service may also take historical power consumption data from each of region A server farm 302 and region B server farm 314 (and in some examples energy type data 312 and energy type data 324) and apply a power consumption prediction model to that data to determine likely future power consumption workloads for each of region A server farm 302 and region B server farm 314. In some examples, the power consumption prediction model may be incorporated in carbon footprint prediction model 336. In additional examples, the power consumption model and/or carbon footprint prediction model 336 may comprise a Monte Carlo model. Once the likely future power consumption workloads for each of region A server farm 302 and region B server farm 314 are determined, the asset disposition service may apply carbon footprint prediction model to those values to determine likely carbon emission values for a future timeframe, as illustrated by CO2 emissions projections 338. Those projections and corresponding values may then be associated with the computing workloads that are projected to be the cause of the projected power consumption, and the server farm IDs, and transformed by insight engine 340 into projected sustainability insights (e.g., insights about future greenhouse gas emissions corresponding to data processing that is projected to be performed by region A server farm 302 and region B server farm 314). The projected sustainability insights in this example may include the CO2 emissions bar corresponding to 2021 under service region A in sustainability insight 342, as well as the CO2 emission bar corresponding to 2021 under service region B in sustainability insight 342. In some examples, a selection may be made of elements at the top portion of sustainability insight 342 to switch the insights in relation to different services (e.g., business services, cloud infrastructure, developer services).

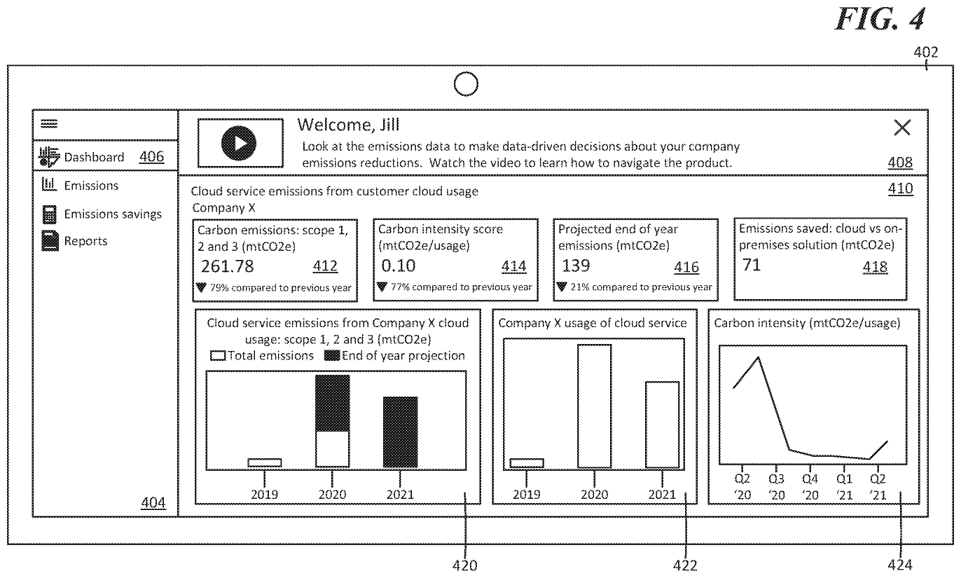

FIG. 4 illustrates a plurality of sustainability insights surfaced on a cloud computing dashboard user interface 410. FIG. 4 includes computing device 402, which comprises selection window 404, dashboard selection element 406, dashboard heading 408, and cloud computing dashboard user interface 410. Cloud computing dashboard user interface 410 further includes first sustainability insight 412, second sustainability insight 414, third sustainability insight 416, fourth sustainability insight 418, fifth sustainability insight 420, sixth sustainability insight 422, and seventh sustainability insight 424.

In this example, a user has selected dashboard selection element 406 in selection window 404, which causes dashboard heading 408 and cloud computing dashboard user interface 410 to be surfaced. Dashboard heading 408 includes the description “Welcome, Jill—Look at the emissions data to make data driven decisions about your company emissions reductions. Watch the video to learn how to navigate the product.” Jill is an employee of Company X. Dashboard user interface 410 includes a plurality of sustainability insights related greenhouse gas emissions for Company X. That is, Company X is a company that utilizes cloud computing resources of a cloud service that has its computing assets managed by the asset disposition service. The asset disposition service may generate sustainability insights from the use of its cloud service by Company X (e.g., Company X's use of virtual machines that are managed by the asset disposition service, Company X's use of virtual cores that are managed by the asset disposition service). Those sustainability insights may be generated based on analyzing data associated with software objects corresponding to the computing assets that Company X's computing workloads are hosted on. Exemplary sustainability insights are surfaced on cloud computing dashboard user interface 410.

First sustainability insight 412 states “Carbon emissions: scope 1, 2 and 3 (mtCO2e)”, and has the value 261.78 in it, which specifies that the use of the cloud service to host Company X's computing workloads in the current year has resulted in 261.78 metric tons of CO2 (greenhouse gas emissions). First sustainability insight 412 also includes a description that this value of greenhouse gas emissions from use of the cloud service is down 79% compared to the previous year. First sustainability insight 412 relates to all three emission scopes. Scope 1 refers to all direct emissions from the activities of an organization or under their control, including fuel combustion on site such as gas broilers, fleet vehicles and air conditioning leaks. Scope 2 refers to indirect emissions from electricity purchased and used by an organization. Scope 3 refers to all other indirect emissions from activities of an organization occurring from sources that an organization does not own or control (e.g., emissions associated with business travel, procurement, waste and water).

Second sustainability insight 414 states “Carbon intensity score (mtCO2e/usage)”, and has the value 0.10 in it corresponding to the carbon intensity score for utilizing the cloud service to host Company X's computing workloads in the current year. Second sustainability insight 414 also includes a description that this carbon intensity score is down 77% compared to the previous year.

Third sustainability insight 416 states “Projected end of year emissions (mtCO2e)”, with the value 139 in it, which specifies that the projected CO2 emissions for the current year are 139 mtCO2e. Third sustainability insight 414 also includes a description that this value is down 21% compared to the previous year.

Fourth sustainability insight 418 states “Emissions saved: cloud vs on-premises solution (mtCO2e)”, and has the value 71 in it. Thus, fourth sustainability insight 418 illustrates that Company X has saved 71 mtCO2e in the current year by moving its computing workloads to the cloud service.

Fifth sustainability insight 420 states “cloud service emissions from Company X cloud usage: scope 1, 2 and 3 (mtCO2e)”. Fifth sustainability insight 420 also includes a first bar insight object for 2019, with the height of that bar corresponding to the total carbon emissions for Company X's use of the cloud service in 2019. Fifth sustainability insight 420 further includes a second bar insight object for 2020, with the height of that bar corresponding to the total projected emissions for Company X's use of the cloud service in 2020. A first portion of the second bar insight is illustrated in a first display type (e.g., white), which illustrates the actual determined carbon emissions in 2020, and a second portion of the second bar insight is illustrated in a second display type (e.g., black), which illustrates that the emissions corresponding to that portion of the bar are projected (e.g., determined based on projected cloud use by Company X). Fifth sustainability insight 420 further includes a third bar insight object for 2021, with the height of that bar corresponding to total projected emissions for Company X's use of the cloud service in 2021. The entirety of that third bar is displayed in black, indicating that it is based completely off of projected use of the cloud service by Company X (e.g., because 2021 is in the future). The projections may be made based on application of a Monte Carlo model to historical cloud use data for Company X (e.g., number of virtual machines or virtual cores) utilized by Company X. In some examples, the Monte Carlo model may be applied to additional variables, such as forelog and backlog orders for virtual machines or virtual cores for Company X, as well as historical spikes in computing resource usage for days, months and years, and any computing workload estimates provided to the cloud service by Company X.

Sixth sustainability insight 422 states “Company X usage of cloud service”, and has a bar chart with three bar insight objects. The height of the first bar insight object on the far left of sustainability insight 422 corresponds to Company X's usage of the cloud service in 2019. The height of the second bar insight object tin the middle of sustainability insight 422 corresponds to Company X's usage of the cloud service in 2020. The height of the third bar insight object on the far right of sustainability insight 422 corresponds to Company X's projected usage of the cloud service in 2021. The “usage” may correspond to a number of virtual cores that were utilized by Company X, a number of virtual machines that were utilized by Company X, or some other cloud computing usage metric that may be associated with the corresponding software objects as attributes in an object library maintained by the asset disposition service.

Seventh sustainability insight 424 states “Carbon intensity (mtCO2e/usage)”, and has a line chart illustrating the actual carbon intensity scores for Company X's usage of the cloud service for 2020 (quarters two, three and four), in addition to projected carbon intensity scores for Company X's usage of the cloud service for 2021 (quarters one and two).

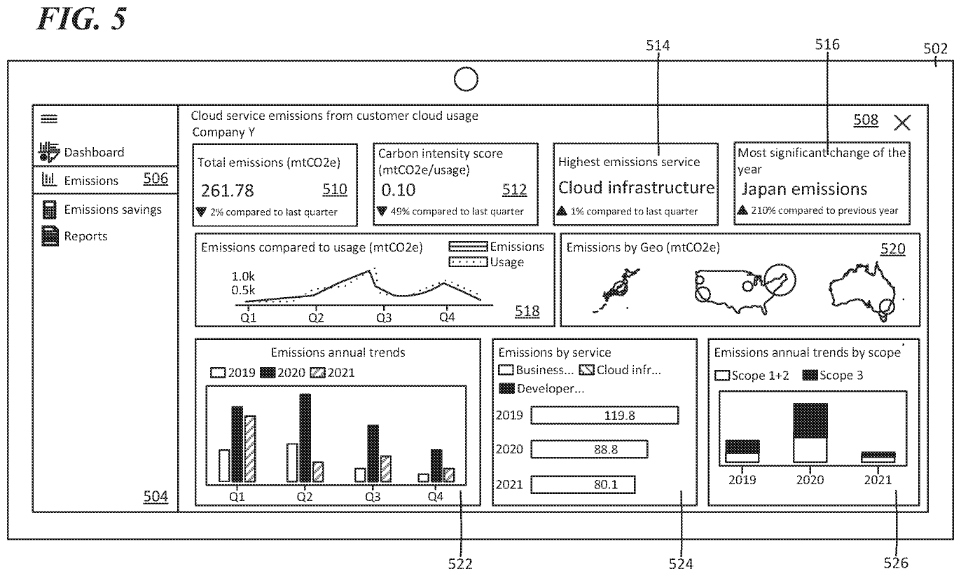

FIG. 5 illustrates a plurality of sustainability insights surfaced on a cloud computing emissions user interface 508. FIG. 5 includes computing device 502, which comprises selection window 504, emissions selection element 506, and cloud computing emissions user interface 508. Cloud computing emissions user interface 508 further includes first sustainability insight 510, second sustainability insight 512, third sustainability insight 514, fourth sustainability insight 516, fifth sustainability insight 518, sixth sustainability insight 520, seventh sustainability insight 522, eighth sustainability insight 524, and ninth sustainability insight 526.

In this example, a user has selected emissions selection element 506 in selection window 504, which causes cloud computing emissions user interface 508 to be surfaced. Cloud computing emissions user interface 508 includes the text “Cloud service emissions from customer cloud usage—Company Y”, as well as a plurality of sustainability insights related to greenhouse gas emissions for Company Y. That is, Company Y is a company that utilizes cloud computing resources of a cloud service that has its computing assets managed by the asset disposition service. The asset disposition service may generate sustainability insights from the use of its cloud service by Company Y (e.g., Company Y's use of virtual machines that are managed by the asset disposition service). Those sustainability insights may be generated based on analyzing data associated with software objects corresponding to the computing assets that Company Y's computing workloads are hosted on. Exemplary sustainability insights are surfaced on cloud computing emissions user interface 508.

First sustainability insight 510 states “Total emissions (mtCO2e”, and has the value 261.78 in it, which specifies that the use of the cloud service to host Company Y's computing workloads in the current year has resulted in 261.78 metric tons of CO2 (greenhouse gas emissions). First sustainability insight 510 also includes a description that this value of greenhouse gas emissions from use of the cloud service is down 2% compared to the previous year.

Second sustainability insight 512 states “Carbon intensity score (mtCO2e/usage)”, and has the value 0.10 in it corresponding to the carbon intensity score for utilizing the cloud service to host Company Y's computing workloads in the current year. Second sustainability insight 512 also includes a description that this carbon intensity score is down 49% compared to the previous year.

Third sustainability insight 514 states “Highest emissions service—Cloud infrastructure”. Third sustainability insight 514 also includes a description that the CO2 emissions for hosting Company Y's cloud infrastructure are up 1% compared to the last quarter.

Fourth sustainability insight 516 states “Most significant change of the year—Japan emissions”. Third sustainability insight 516 also includes a description that the CO2 emissions for Company Y's cloud computing workload in Japan are up 210% compared to the previous year. The asset disposition service may have determined that CO2 emission values that resulted in the generation of sustainability insight 516 by analyzing software objects corresponding to each of the server computing devices/computing assets that were utilized in hosting Company Y's computing workload. Those software objects may include locational attributes that were utilized in determining the locational data illustrated in fourth sustainability insight 516. The CO2 emission amounts may have been determined based on application of a carbon footprint prediction model to computing workload attributes and energy type attributes for the server farms where the workloads were executed.

Fifth sustainability insight 518 is a line graph, with two different lines. A first solid line represents CO2 emissions for company Y's cloud computing workload for quarters one through four, and a second dotted line represents cloud computing usage (e.g., virtual cores, virtual machines, etc.) on the cloud service for those same quarters.

Sixth sustainability insight 520 states “emissions by Geo (mtCO2e)”. Sixth sustainability insight 520 displays three countries (Japan, United States, Australia) where the cloud service hosts Company Y's cloud computing workload. Each of those countries has circles on them at the various locations where the cloud computing workload is handled by the cloud service. The size of the circle may correspond to an amount of CO2 emissions (e.g., mtCO2e) in that location (e.g., larger circle may equate to higher emissions), and a color or pattern of the circle may represent carbon intensity by usage.

Seventh sustainability insight 522 is a bar graph with the title “Emissions annual trends”. Seventh sustainability insight 522 includes three bars for each of quarters one two, three and four, with a first (white) bar corresponding to CO2 emissions for Company Y's use of the cloud service for 2019, a second (black) bar corresponding to CO2 emissions for Company Y's use of the cloud service for 2020, and a third (diagonal line) bar corresponding to projected CO2 emissions for Company Y's use of the cloud service for 2021.

Eighth sustainability insight 526 is another bar graph with the title “Emissions annual trends by scope”. Eighth sustainability insight 526 includes three bars—one for each of 2019, 2020 and 2021. Each bar is divided into two components. A first component (in white) corresponds to the amount of scope one and two CO2 emissions that were generated based on the hosting of Company Y's computing workload by the cloud computing service. A second component (in black) corresponds to the amount of scope three CO2 emissions that were generated base don the hosting of Company Y's computing workload by the cloud computing service.

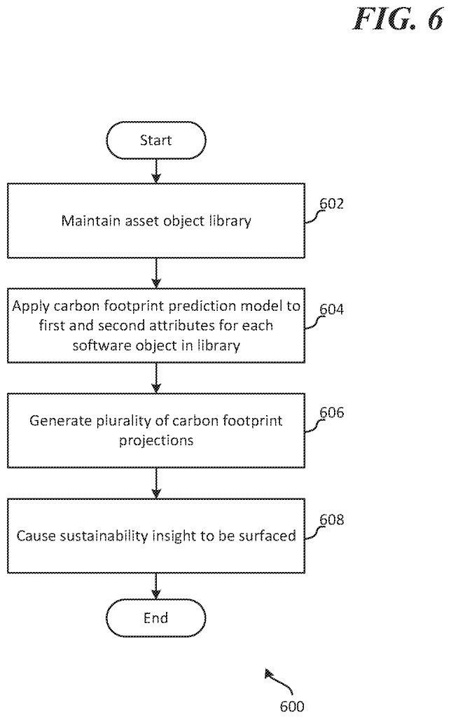

FIG. 6 is an exemplary method 600 for generating and surfacing interactive sustainability insights. The method 600 begins at a start operation and flow moves to operation 602.

At operation 602 a plurality of software objects that each represent a server of a cloud computing service are maintained. Each of the plurality of software objects is associated with a company's computing workload. That is, the company executes a computing workload on one or more virtual machines and/or virtual cores on each of the plurality of server computing devices corresponding to the software objects. Additionally, each of the plurality of software objects may comprise a first attribute corresponding to a device ID of each server, wherein each device ID is associated in a corresponding software object with a specific server farm and a type of energy (e.g., hydroelectric, wind, coal, gas, etc.) utilized to power the specific server farm. Each of the plurality of software objects may further comprise a second attribute corresponding to a computing workload handled by each server.

In examples, the second attribute may be automatically updated in real or near real time based on data received via a computer network from one or more data stores (e.g., power consumption data store 108, efficiency data store 112). For example, as computing workloads for the server computing devices change, information associated with those modifications may be communicated to the data stores, and the data stores may communicate that information to an object library where various attributes (e.g., the second attribute) can be automatically updated to reflect those modifications.

From operation 602 flow continues to operation 604 where a carbon footprint prediction model is applied to the first attribute and the second attribute for each of the plurality of software objects. The carbon footprint prediction model may have been trained to determine a CO2 emissions value based on computing workloads (e.g., how many virtual cores or virtual machines are utilized) and the type of power that is utilized to power the corresponding computing devices.

From operation 604 flow continues to operation 606 where a plurality of carbon footprint projections is generated based on the application of the carbon footprint prediction model. The projections may comprise historical carbon footprint metrics, current carbon footprint metrics, and/or future carbon footprint metrics. The plurality of carbon footprint projections may additionally or alternatively include projections for CO2 emissions should the computing assets handle the computing workload at different times or via different processing mechanisms.

From operation 606 flow continues to operation 608 where an interactive sustainability insight for the company's computing workload is caused to be surfaced. The interactive sustainability insight may comprise one or more objects (e.g., graph objects, written objects, details regarding why the insight was provided, etc.). A graph object of the interactive sustainability insight may be interacted with to cause various predictive outcomes to be displayed and modified. For example, a user may interact with a graph object that represents a data center by raising or lowering future projected CO2 emissions for the data center via the object. In another example, a user may modify where computing workloads are hosted via interaction with an interactive object. In additional examples, a user may modify sustainability company goals via an interactive object, and one or more dependent other objects or object values may be automatically updated based on that interaction. In still other examples, a graph object of the interactive sustainability insight may be interacted with to cause one or more actions to be taken in relation to the software objects and corresponding servers. For example, a graph object may indicate that running server workloads for a data center at different times of day may result in reduced CO2 emissions and that object may be interacted with to initiate a change in times when the workloads are run on the servers for the data center. In additional examples, the asset disposition service may automatically modify server workload times upon determining, based on carbon footprint projections, that such a modification is likely to result in at least a threshold value of CO2 emissions savings.

From operation 608 flow continues to an end operation and the method 600 ends.

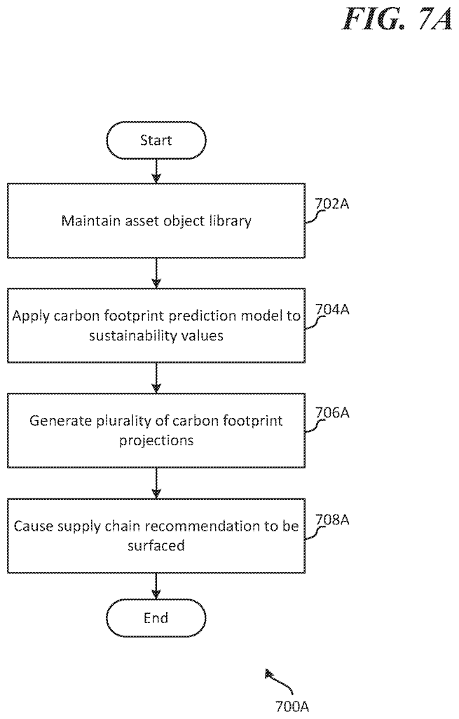

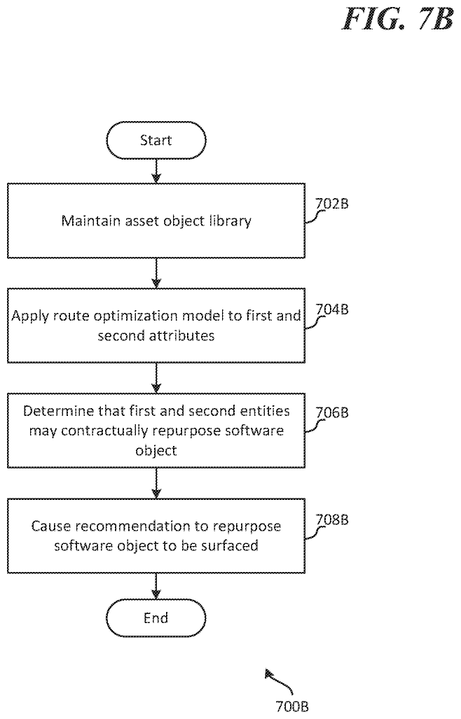

FIG. 7A is an exemplary method 700A for providing a recommendation related to the supply chain of a computing asset. The method 700A begins at a start operation and flow moves to operation 702A.

At operation 702A an asset object library is maintained. The asset object library comprises a first software object that represents a computer hardware asset (e.g., a server, a router, a client computing device, a mouse, a keyboard). The first software object may comprise a first attribute corresponding to a device class of the computer hardware asset. The first software object may further comprise a second attribute corresponding to a device type of the computer hardware asset, wherein the second attribute is associated in the software object with a manufacturing material. The first software object may further comprise a third attribute corresponding to a device ID of the computer hardware asset. The device ID may be associated in the software object with a plurality of vendors in a supply chain of the computer hardware asset. Each vendor may be associated in the software object with sustainability values comprising a shipping fuel type, a shipping origin geographic location (e.g., where an asset is being shipped from), and a shipping destination geographic location (e.g., where an asset is being shipped to).

According to some examples, the first attribute may be associated in the software object with a government regulation. In additional examples, each vendor may be associated in the software object with a sentiment value corresponding to at least one report reflecting a previous interaction with the device class of the computer hardware asset. For example, the first software object may be associated with one or more electronic reports that are indicative of equipment failures in the supply chain of the computer hardware object, shortages in availability of materials or equipment in the supply chain of the computer hardware object, or reviews in performing actions in the supply chain of the computer hardware object. The asset disposition service may analyze those electronic reports (e.g., apply machine learning model to reports, apply natural language processing model to reports) and determine the sentiment value based on the analysis.

From operation 702A flow continues to operation 704A where a carbon footprint prediction model is applied to the sustainability values for each of the plurality of vendors for the software object. The carbon footprint prediction model may have been trained to determine a CO2 emissions value based on shipping distances, weight of computing assets, and the type of power that is utilized to power the shipping carrier.

From operation 704A flow continues to operation 706A where a plurality of carbon footprint projections is generated based on the application of the carbon footprint prediction model. The projections may comprise historical carbon footprint metrics, current carbon footprint metrics, and/or future carbon footprint metrics. The projections may comprise actual vendors that were utilized in the supply chain for the computer hardware asset and/or vendors that were not utilized in the supply chain for the computer hardware asset, but for which sustainability values are available and associated with the first software object.

From operation 706A flow continues to operation 708A where a supply chain recommendation related to at least one of the carbon footprint projections is caused to be surfaced. The supply chain recommendation may comprise one or more graphs corresponding to sustainability metrics related to different vendors that may be utilized in obtaining the computer hardware asset and/or cost metrics related to different vendors that may be utilized in obtaining the computer hardware asset.

From operation 708A flow moves to an end operation and the method 700A ends.

FIG. 7B is an exemplary method 700B for providing a recommendation related to repurposing of a software object for a second phase of its computing lifecycle. The method 700B begins at a start operation and flow moves to operation 702B.

At operation 702B an asset object library is maintained. The asset object library may comprise a first software object that represents a computer hardware asset. The first software object may comprise a first attribute corresponding to a device class of the computer hardware asset, wherein the first attribute is associated in the software object with a government regulation. The first software object may further comprise a second attribute corresponding to a device type of the computer hardware asset, wherein the second attribute is associated in the software object with an end-of use term in a contract. The first software object may further comprise a third attribute corresponding to a device ID of the computer hardware asset.

From operation 702B flow continues to operation 704B where a route optimization computing model is applied to the first attribute and the second attribute. The route optimization computing model may comprise a graph model. In examples, the route optimization computing model may be applied to the first attribute and the second attribute based on determining that the first software object is within a threshold duration of time from the end of its first phase of a computing lifecycle.

From operation 704B flow continues to operation 706B where a determination is made based on the application of the route optimization computing model that a first entity and a second entity may contractually repurpose the first software object in a second phase of the computing lifecycle.

From operation 706B flow continues to operation 708B where a recommendation to repurpose the first software object by the second entity is caused to be surfaced.

From operation 708B flow continues to an end operation and the method 700B ends.

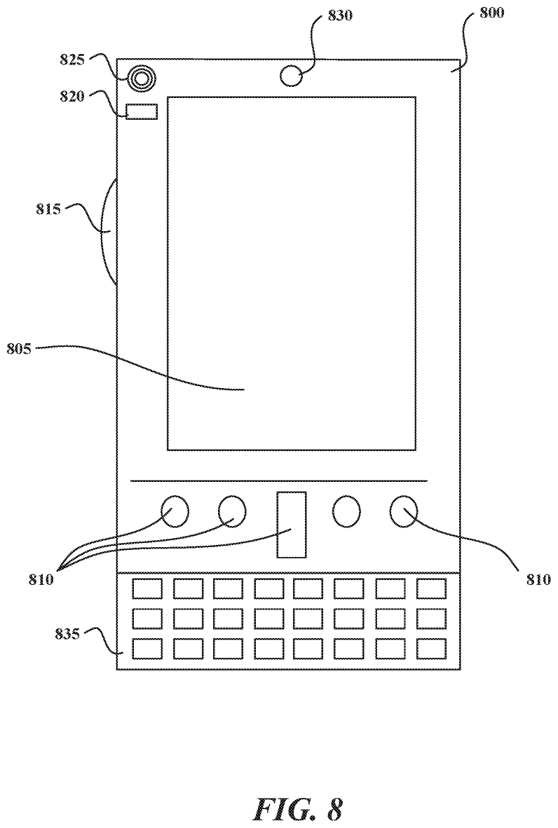

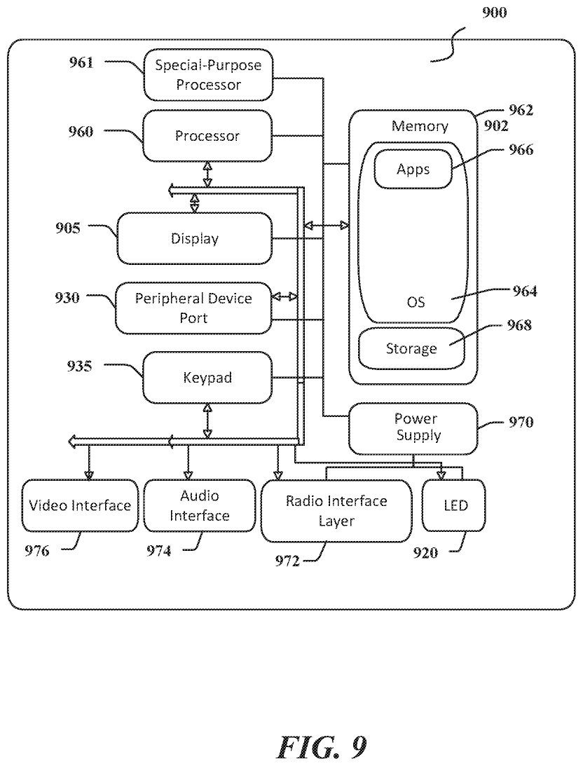

FIGS. 8 and 9 illustrate a mobile computing device 800, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 8, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display). If included, an optional side input element 815 allows further user input. The side input element 815 may be a rotary switch, a button, or any other type of manual input element. In alternative aspects, mobile computing device 800 may incorporate more or fewer input elements. For example, the display 805 may not be a touch screen in some embodiments. In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display. In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 9 is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900, including instructions for providing and operating an asset disposition engine.

The system 902 has a power supply 970, which may be implemented as one or more batteries. The power supply 970 might further include an external power source, such as an AC adapter or a powered docking cradle that supplements or recharges the batteries.

The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 820 may be used to provide visual notifications, and/or an audio interface 974 may be used for producing audible notifications via the audio transducer 825. In the illustrated embodiment, the visual indicator 820 is a light emitting diode (LED) and the audio transducer 825 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 825, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of an on-board camera 830 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9 by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

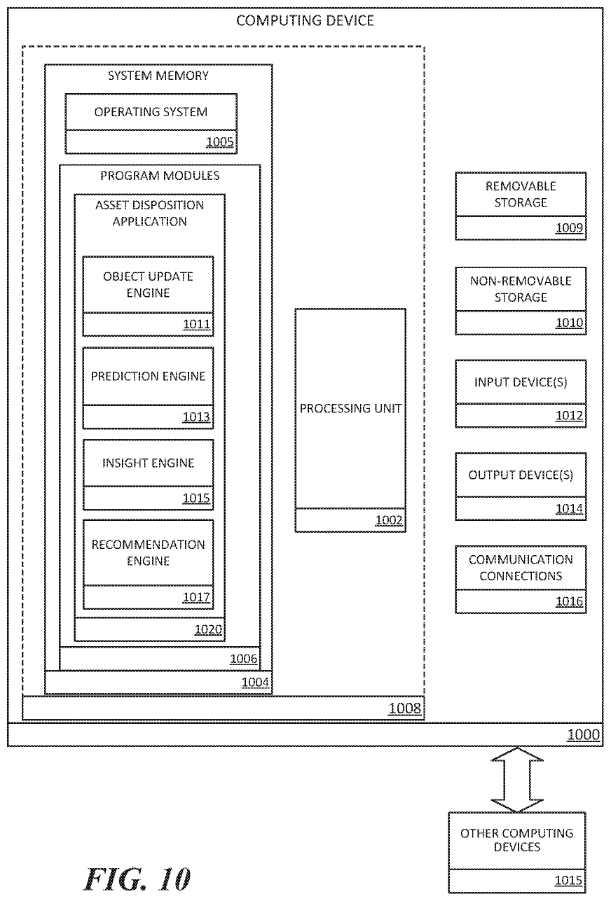

FIG. 10 is a block diagram illustrating physical components (e.g., hardware) of a computing device 1000 with which aspects of the disclosure may be practiced. The computing device components described below may have computer executable instructions for assisting with generating sustainability insights and recommendations. In a basic configuration, the computing device 1000 may include at least one processing unit 1002 and a system memory 1004. Depending on the configuration and type of computing device, the system memory 1004 may comprise, but is not limited to, volatile storage (e.g., random access memory), non-volatile storage (e.g., read-only memory), flash memory, or any combination of such memories. The system memory 1004 may include an operating system 1005 suitable for running one or more asset disposition applications. The operating system 1005, for example, may be suitable for controlling the operation of the computing device 1000. Furthermore, embodiments of the disclosure may be practiced in conjunction with a graphics library, other operating systems, or any other application program and is not limited to any particular application or system. This basic configuration is illustrated in FIG. 10 by those components within a dashed line 1008. The computing device 1000 may have additional features or functionality. For example, the computing device 1000 may also include additional data storage devices (removable and/or non-removable) such as, for example, magnetic disks, optical disks, or tape. Such additional storage is illustrated in FIG. 10 by a removable storage device 1009 and a non-removable storage device 1010.

As stated above, a number of program modules and data files may be stored in the system memory 1004. While executing on the processing unit 1002, the program modules 1006 (e.g., asset disposition application 1020) may perform processes including, but not limited to, the aspects, as described herein. According to examples, object update engine 1011 may receive data related to computing assets from one or more data stores and update corresponding attributes in software objects for those computing assets based on that date. Prediction engine 1013 may perform one or more operations associated with predicting computing workloads on servers and at various server farm locations. In some examples, prediction engine 1013 may utilize a Monte Carlo model in predicting the computing workloads. Insight engine 1015 may perform one or more operations associated with generating and surfacing sustainability insights related computing assets managed by the asset disposition service. Recommendation engine 1017 may perform one or more operations associated with generating and surfacing sustainability recommendations related to computing assets managed by the asset disposition service.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 10 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1000 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1000 may also have one or more input device(s) 1012 such as a keyboard, a mouse, a pen, a sound or voice input device, a touch or swipe input device, etc. The output device(s) 1014 such as a display, speakers, a printer, etc. may also be included. The aforementioned devices are examples and others may be used. The computing device 1000 may include one or more communication connections 1016 allowing communications with other computing devices 1050. Examples of suitable communication connections 1016 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1004, the removable storage device 1009, and the non-removable storage device 1010 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1000. Any such computer storage media may be part of the computing device 1000. Computer readable media and computer storage media as described herein does not include transitory media such as a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

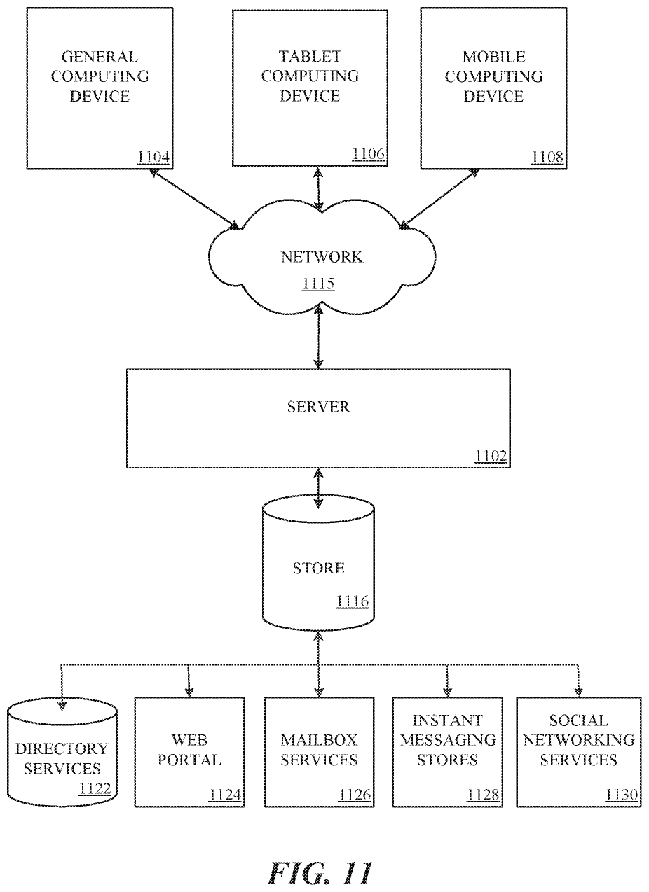

FIG. 11 illustrates one aspect of the architecture of a system for processing data received at a computing system from a remote source, such as a personal/general computer 1104, tablet computing device 1106, or mobile computing device 1108, as described above. Content displayed at server device 1102 may be stored in different communication channels or other storage types. For example, various documents may be stored using a directory service 1122, a web portal 1124, a mailbox service 1126, an instant messaging store 1128, or a social networking site 1130. The program modules 1006 may be employed by a client that communicates with server device 1102, and/or the program modules 1006 may be employed by server device 1102. The server device 1102 may provide data to and from a client computing device such as a personal/general computer 1104, a tablet computing device 1106 and/or a mobile computing device 1108 (e.g., a smart phone) through a network 1115. By way of example, the computer system described above may be embodied in a personal/general computer 1104, a tablet computing device 1106 and/or a mobile computing device 1108 (e.g., a smart phone). Any of these embodiments of the computing devices may obtain content from the store 1116, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure. The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A system for generating interactive sustainability insights, comprising:
a memory for storing executable program code; and
a processor, functionally coupled to the memory, the processor being responsive to computer-executable instructions contained in the program code and operative to:
maintain an asset object library comprising:
a plurality of software objects that each represent a server of a cloud computing service, wherein each of the plurality of software objects is associated with a company's computing workload, and wherein each of the plurality of software objects comprises:
a first attribute corresponding to a device ID of each server, wherein each device ID is associated in a corresponding software object with a specific server farm and a type of energy utilized to power the specific server farm, and
a second attribute corresponding to a computing workload handled by each server;
apply a carbon footprint prediction model to the first attribute and the second attribute for each of the plurality of software objects;
generate a plurality of carbon footprint projections based on the application of the carbon footprint prediction model; and
cause an interactive sustainability insight for the company's computing workload to be surfaced.

2. The system of claim 1, wherein each of the plurality of carbon footprint projections is an estimated CO2 emission for executing the company's computing workload by a cloud service from a first time and date to a second time and date.

3. The system of claim 2, wherein the processor is further responsive to the computer-executable instructions contained in the program code and operative to:
apply a Monte Carlo model to the second attribute to determine an estimated amount of power to be utilized in executing the company's computing workload from the first time and date to the second time and date.

4. The system of claim 2, wherein the processor is further responsive to the computer-executable instructions contained in the program code and operative to:
determine, based on the application of the carbon footprint prediction model, that:
a first geographic region of a cloud service that hosts the company's computing workload is estimated to be responsible for a first value of CO2 emissions from the first time and date to the second time and date; and
a second geographic region of the cloud service that hosts the company's computing workload is estimated to be responsible for a second value of CO2 emissions from the first time and date to the second time and date.

5. The system of claim 4, wherein the processor is further responsive to the computer-executable instructions contained in the program code and operative to:
cause the first value of CO2 emissions to be represented in a first graph object of the surfaced interactive sustainability insight with an identity of the first geographic region of the cloud service; and
cause the second value of CO2 emissions to be represented in a second graph object of the surfaced interactive sustainability insight with an identity of the second geographic region of the cloud service.

6. The system of claim 1, wherein the processor is further responsive to the computer-executable instructions contained in the program code and operative to:
determine, based on application of the carbon footprint prediction model, for the company's computing workload for a future timeframe, a first value of CO2 emissions; and
determine, for the company's computing workload from a past timeframe, a second value of CO2 emissions.

7. The system of claim 6, wherein the processor is further responsive to the computer-executable instructions contained in the program code and operative to:
cause the first value of CO2 emissions to be represented in a first graph object of the surfaced interactive sustainability insight; and
cause the second value of CO2 emissions to be represented in a second graph object of the surfaced interactive sustainability insight.

8. The system of claim 1, wherein the processor is further responsive to the computer-executable instructions contained in the program code and operative to:
determine, based on the application of the carbon footprint prediction model, that running a specific software computing workload of the company's computing workload during a first temporal period of a day results in a first value of CO2 emissions;
determine, based on the application of the carbon footprint prediction model, that running the specific software computing workload of the company's computing workload during a second temporal period of the day results in a second value of CO2 emissions that is less that the first value of CO2 emissions; and
cause a recommendation to run the specific software computing workload during the second temporal period of the day to be surfaced.

9. The system of claim 1, wherein the processor is further responsive to the computer-executable instructions contained in the program code and operative to:
determine, based on the application of the carbon footprint prediction model, that:
a first service workload type, that is a first subset of the company's computing workload, is estimated to be responsible for a first value of CO2 emissions from a first time and date to a second time and date; and
a second service workload type, that is a second subset of the company's computing workload, is estimated to be responsible for a second value of CO2 emissions from the first time and date to the second time and date.

10. The system of claim 9, wherein the processor is further responsive to the computer-executable instructions contained in the program code and operative to:
cause the first value of CO2 emissions to be represented in a first graph object of the surfaced interactive sustainability insight with an identity of the first service workload type; and
cause the second value of CO2 emissions to be represented in a second graph object of the surfaced interactive sustainability insight with an identity of the second service workload type.

11. A computer-implemented method for surfacing a supply chain recommendation, the computer-implemented method comprising:
maintaining an asset object library comprising:
a first software object that represents a computer hardware asset, the first software object comprising:
a first attribute corresponding to a device class of the computer hardware asset,
a second attribute corresponding to a device type of the computer hardware asset, wherein the second attribute is associated in the software object with a manufacturing material, and
a third attribute corresponding to a device ID of the computer hardware asset, wherein:
the device ID is associated in the software object with a plurality of vendors in a supply chain of the computer hardware asset, and
each vendor is associated in the software object with sustainability values comprising:
a shipping fuel type;
a shipping origin geographic location, and
a shipping destination geographic location,
applying a carbon footprint prediction model to the sustainability values for each of the plurality of vendors for the software object;
generating a plurality of carbon footprint projections based on the application of the carbon footprint prediction model; and
causing a supply chain recommendation related to at least one of the carbon footprint projections to be surfaced.

12. The computer-implemented method of claim 11, wherein:
the first attribute is associated in the software object with a government regulation; or
each vendor is further associated in the software object with a sentiment value corresponding to at least one report reflecting a previous interaction with the device class of the computer hardware asset.

13. The computer-implemented method of claim 11, wherein each of the plurality of carbon footprint projections is an estimated CO2 emission for manufacturing the computer hardware asset and getting the computer hardware asset to a point of installation in a server farm.

14. The computer-implemented method of claim 11, further comprising:
selecting the carbon footprint prediction model based on the shipping fuel type.

15. The computer-implemented method of claim 11, further comprising:
generating a first carbon footprint projection for a first vendor of the plurality of vendors in the supply chain;
generating a second carbon footprint projection for a second vendor of the plurality of vendors in the supply chain; and
determining, for the computer hardware asset, that the first carbon footprint projection comprises a lower CO2 emissions output than the second carbon footprint.

16. The computer-implemented method of claim 15, wherein the supply chain recommendation comprises a recommendation to utilize the first vendor in manufacturing the computer hardware asset based on the first carbon footprint projection comprising a lower CO2 emission output than the second carbon footprint.

17. The computer-implemented method of claim 11, wherein the second attribute is further associated in the software object with an alternative manufacturing material, and wherein the computer-implemented method further comprises:
generating a carbon footprint projection utilizing a least one value associated with the alternative manufacturing material as in input to the carbon footprint prediction model.

18. A computer-readable storage device comprising executable instructions that, when executed by a processor, assists with providing a recommendation for disposition of computing assets, the computer-readable storage device including instructions executable by the processor for:
maintaining an asset object library comprising:
a first software object that represents a computer hardware asset, the first software object comprising:
a first attribute corresponding to a device class of the computer hardware asset, wherein the first attribute is associated in the software object with a government regulation,
a second attribute corresponding to a device type of the computer hardware asset, wherein the second attribute is associated in the software object with an end-of-use term in a contract, and
a third attribute corresponding to a device ID of the computer hardware asset;
applying a route optimization computing model to the first attribute and the second attribute;
determining, based on application of the route optimization computing model, that a first entity and a second entity may contractually repurpose the first software object in a second phase of the computing lifecycle; and
causing a recommendation to repurpose the first software object by the second entity to be surfaced.

19. The computer-readable storage device of claim 18, wherein the instructions are further executable by the processor for:
determining that the computer hardware asset is at the end of its lifecycle;
applying the route optimization computing model to the first attribute and the second attribute;
determining a process with a lowest CO2 emission value for decommissioning the computer hardware asset; and
causing a recommendation for decommissioning the computer hardware asset via the process to be surfaced.

20. The computer-readable storage device of claim 18, wherein the contract is managed utilizing blockchain technology.
